(19) United States
(12) Patent Application Publication
(10) Pub. No.: US 2016/0023394 A1
(43) Pub. Date: Jan. 28, 2016

(54) CUP-MAKING PROCESS

(71) Applicant: Berry Plastics Corporation, Evansville, IN (US)

(72) Inventors: DAVID DEZHOU SUN, Evansville, IN (US); John B. Euler, Evansville, IN (US)

(21) Appl. No.: 14/804,964

(22) Filed: Jul. 21, 2015

Related U.S. Application Data
(60) Provisional application No. 62/027,546, filed on Jul. 22, 2014.

(51) Int. Cl. B29C 47/00

(52) U.S. Cl. CPC B29C 47/0064; B29C 47/0066; B29C 2793/009; B29K 2023/12

(57) ABSTRACT

An insulative cup is produced by mounting a floor on a lower portion of a sleeve-shaped side wall Inner surfaces of the side wall and floor cooperate to form an interior region of the insulative cup.

### PRIORITY CLAIM

This application claims priority under 35 U.S.C. § 119(e) to U.S. Provisional Application Ser. No. 62/027,546, filed Jul. 22, 2014, which is expressly incorporated by reference herein.

### BACKGROUND

The present disclosure relates to vessels, and particularly to insulated containers, such as cups, for containing hot or cold beverages or food. More particularly, the present disclosure relates to a process for making an insulated cup using polymeric materials.

### SUMMARY

According to the present disclosure, an insulative cup is produced by mounting a floor on a lower portion of a sleeve-shaped side wall Inner surfaces of the side wall and floor cooperate to form an interior region of the insulative cup.

In an illustrative process in accordance with the present disclosure, an insulative cellular non-aromatic polymeric material is extruded to produce a tubular extrudate and a section of the tubular extrudate is used to provide a floor that will be mounted on the sleeve-shaped side wall to form an insulative cup. The tubular extrudate has an interior surface bounding a central extrudate passageway extending through the tubular extrudate along its length. The tubular extrudate also has an exterior surface.

Once the insulative cup has been formed in accordance with the present disclosure, a first side of the floor bounding the interior region of the insulative cup is defined by the interior surface of the section of the tubular extrudate that was used to form the floor. An opposite second side of the floor facing away from the interior region of the insulative cup is defined by the exterior surface of the section of the tubular extrudate that was used to form the floor.

In an illustrative process, a first part of the tubular extrudate is used to form the floor and a second part of the tubular extrudate is used to form the sleeve-shaped side wall. The first part of the tubular extrudate is slit along its length and unfolded and cut as needed to form (1) a thin flat floor having a first side that earlier formed a portion of the interior surface of the tubular extrudate and (2) an opposite second side that earlier formed a portion of the exterior surface of the tubular extrudate. Then, the floor is oriented to cause the first side of the floor to cooperate with the inner surface of the sleeve-shaped side wall to form a boundary of the interior region of the insulative cup once the oriented floor is mounted on a lower portion of the sleeve-shaped side wall.

In an illustrative process disclosed herein, the tubular extrudate is transformed into two pieces, oriented, and assembled to produce an insulative cup. An inner surface of the insulative cup is defined only by portions of the interior surface of the tubular extrudate.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a diagrammatic and perspective view of an illustrative material-forming process in accordance with the present disclosure that may be used to make a polymeric material that can be used to make an insulative cup and showing that the material-forming process comprises the steps of, from left to right, loading a formulation of insulative cellular non-aromatic polymeric material into a hopper that is fed into a first extrusion zone of a first extruder where heat and pressure are applied to form molten resin, injecting a blowing agent into the molten resin to form an extrusion resin mixture that is fed into a second extrusion zone of a second extruder, extruding the extrusion resin mixture through a die to cause the mixture to expand and form a tubular extrudate having an interior surface (A) arranged to bound a central extrudate passageway and an opposite exterior surface (B), and slitting the tubular extrudate to form a strip of insulative cellular polymeric material having a first strip surface (A) and a second strip surface (B);

FIG. 2 is a perspective assembly view showing a floor that has been formed from the polymeric material shown in FIG. 1 before it is mounted on a sleeve-shaped side wall of a body that has also been formed from the polymeric material shown in FIG. 1 to produce an insulative cup shown in FIGS. 3 and 4 and showing that the polymeric material used to form the floor is oriented to cause the upwardly and radially outwardly facing first side of the floor to be defined by the first strip surface (A) of the polymeric material shown in FIG. 1;

FIG. 3 is a perspective view of an insulative cup made from the strip of insulative cellular non-aromatic polymeric material shown in FIG. 1 showing that the insulative cup includes a body and a floor having a first side provided by the first strip surface (A) and a second side provided by the second strip surface (B) and showing that the first side of the floor is arranged to define a first portion of the boundary of an interior region of the cup; and

FIG. 4 is a sectional view taken along line 4-4 of FIG. 3 showing that an illustrative floor includes a horizontal platform and a depending cylinder-shaped platform-support member (see also FIG. 2) and showing mating engagement of a lower portion of the sleeve-shaped side wall with the cylinder-shaped platform-support member to cause an upwardly facing surface of the horizontal platform to be defined by the first strip surface (A) of the polymeric material shown in FIG. 1 and to cooperate with a portion of the inner surface of the sleeve-shaped side wall to form a boundary of an interior region of the insulative cup.

### DETAILED DESCRIPTION

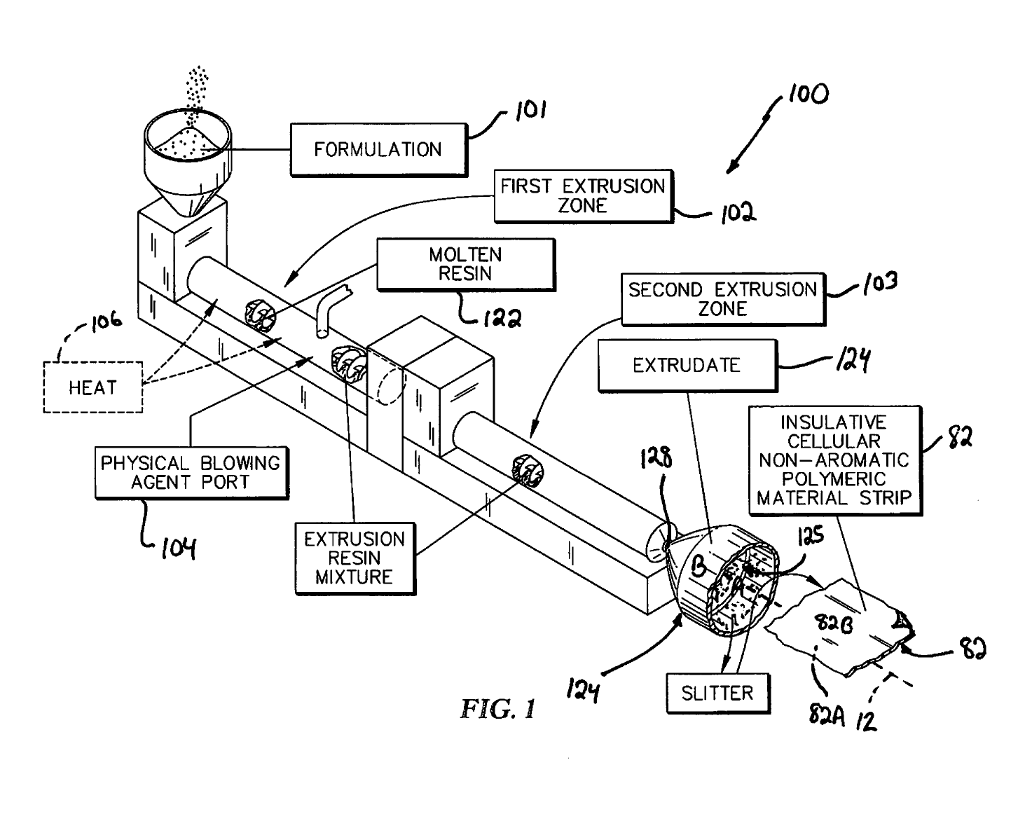

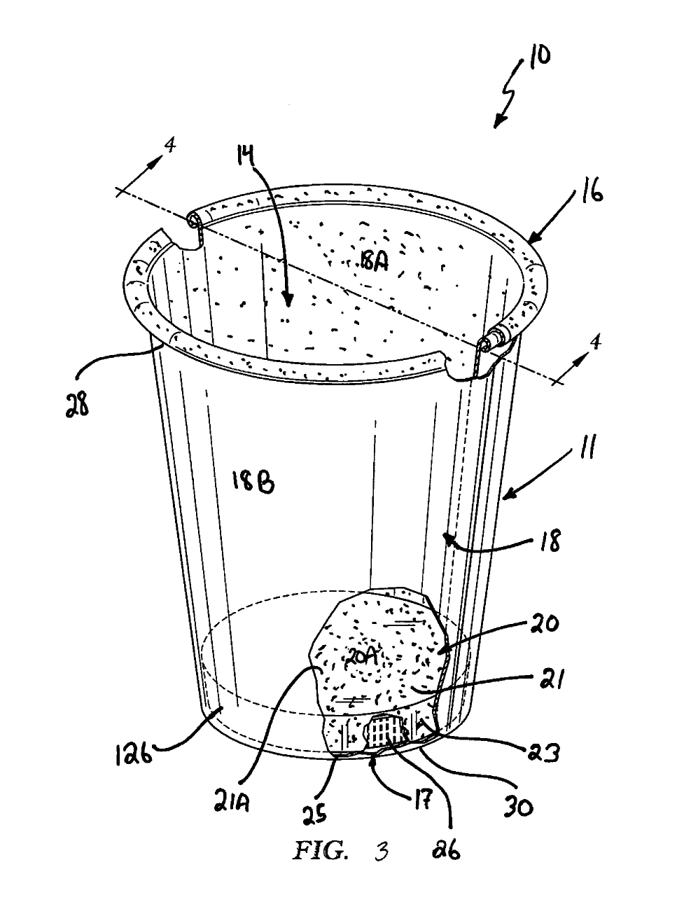

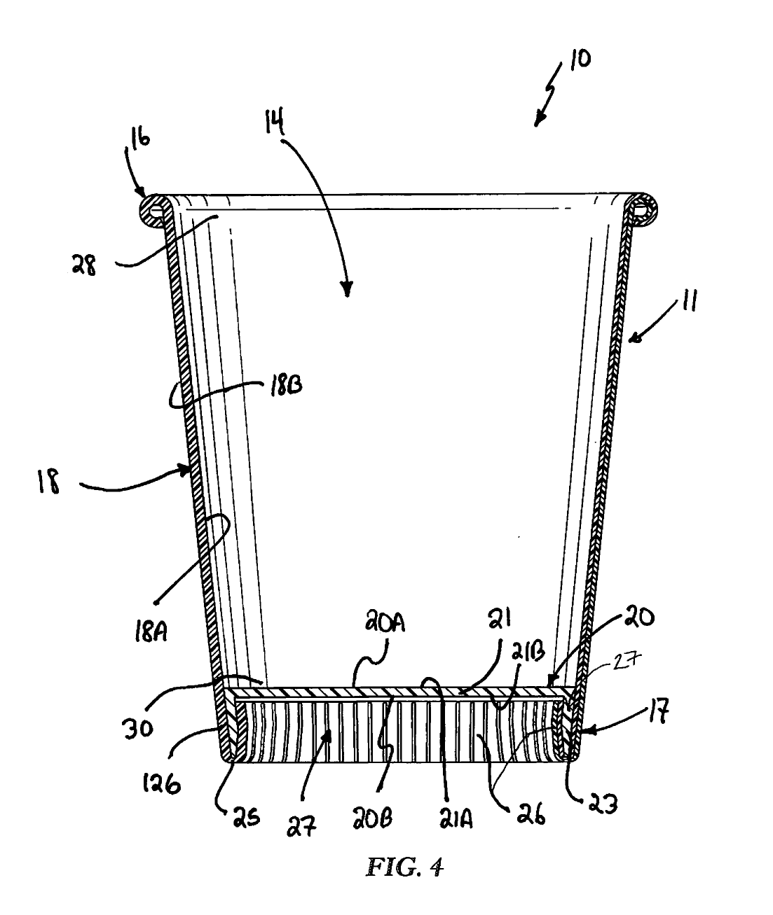

A polymeric material 82 is made by slitting a tubular extrudate 124 in accordance with an illustrative extrusion and slitting process shown in FIG. 1. The polymeric material 82 is formed using any suitable means to produce a body 11 having a sleeve-shaped side wall 18 and a brim 16 and a separate floor 20 that can be mated to body 11 to produce an insulative cup 10 as suggested in FIGS. 3 and 4. Floor 20 is made and oriented to cause an interior surface (A) of tubular extrudate 124 to provide an upwardly facing surface 20A of a horizontal panel 21 included in the floor 20 that cooperates with an inner surface 18A of sleeve-shaped side wall 18 to define a boundary of an interior region 14 of insulative cup 10.

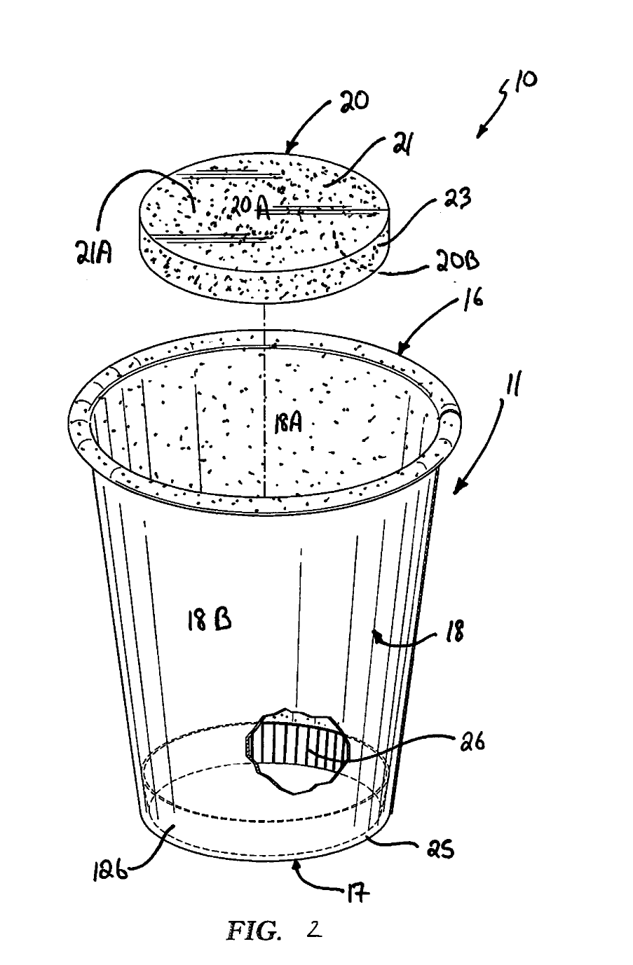

An insulative cellular non-aromatic polymeric material produced in accordance with the present disclosure is formed to produce an insulative cup 10 or container having an interior region 14 as suggested in FIGS. 2-4. An illustrative material-forming process 100 uses a formulation 101 to produce a tubular extrudate 124 made of insulative cellular non-aromatic polymeric material as suggested in FIG. 1. Tubular extrudate 124 includes an interior surface (A) bounding a central extrudate passageway 125 extending along a longitudinal axis 12 and an exterior surface (B) arranged to face opposite inner surface (A) as shown in FIG. 1. Tubular extrudate 124 is then slit to form a strip 82 of insulative cellular non-aromatic polymeric material having a first strip surface (A) and an opposite outer strip surface (B). Strip 82 is then cut using a floor pattern to provide a floor 20 that will be mated with a sleeve-shaped side wall 18 to produce an insulative cup 10 in which the floor 20 has been arranged so that first strip surface (A) of strip provides an inner surface 20A of the floor that defines a first boundary of interior region 14 of insulative cup 10. By orienting floor 20 as disclosed herein to cause first strip surface (A) to provide the first boundary of interior region 14, fracturing of floor 20 during cup forming is minimized.

Formulation 101 is an insulative cellular non-aromatic polymeric material that (in illustrative embodiments) comprises a polypropylene base resin having a polypropylene copolymer or homopolymer (or both), and cell-forming agents including at least one nucleating agent and a blowing agent such as carbon dioxide. As a further example, the insulative cellular non-aromatic polymeric material further comprises a slip agent. The polypropylene base resin has a unimodal (not bimodal) molecular weight distribution.

Material-forming process 100 uses formulation 101 in accordance with the present disclosure to produce strip 82 of insulative cellular non-aromatic polymeric material having first strip surface 82A and an opposite second strip surface 82B as shown in FIG. 1. Heat 106 is applied to formulation 101 in a first extrusion zone 102. Blowing agent 104 in the form of a liquefied inert gas is introduced into a molten resin 122 in first extrusion zone 102. Formulation 101 and a blowing agent 104 are extruded in two stages 102, 103 to produce tubular extrudate 124 that is then slit to provide the strip 82 of insulative cellular non-aromatic polymeric material as illustrated, for example, in FIG. 1. Reference is hereby made to U.S. application Ser. No. 13/491,327 filed on 7 Jun. 2012 and entitled POLYMERIC MATERIAL FOR AN INSULATED CONTAINER, U.S. application Ser. No. 14/063,252 filed on 25 Oct. 2013 and entitled POLYMERIC MATERIAL FOR AN INSULATED CONTAINER, U.S. application Ser. No. 61/866,741 filed on 16 Aug. 2013 and entitled POLYMERIC MATERIAL FOR AN INSULATED CONTAINER, U.S. application Ser. No. 61/949,126 filed on 6 Mar. 2014 and entitled POLYMERIC MATERIAL FOR AN INSULATED CONTAINER for disclosure relating to formulations of insulative cellular non-aromatic polymeric material and those applications in their entirety are incorporated by reference herein.

After strip 82 is formed, the strip 82 is laminated to a printed film. In one example, the printed film is laminated to second strip surface 82B to form a sheet of insulative cellular non-aromatic polymeric material. After the sheet is formed, the sheet is then die cut to form a side-wall blank and a floor blank. The side-wall blank is arranged so that the second strip surface 82B and printed film are arranged to face away from interior region 14 after a cup-forming process is complete. The floor blank is arranged so that the second strip surface 82B and printed film are arranged to face away from interior region 14 after the cup-forming process is complete. Reference is hereby made to U.S. application Ser. No. 13/526,444 filed on 18 Jun. 2012 and entitled PROCESS FOR FORMING AN INSULATED CONTAINER HAVING ARTWORK, which application is incorporated in its entirety herein, for disclosure relating to a process of laminating a printed film to a sheet of insulative cellular non-aromatic polymeric material, forming a side wall blank and floor blank from the sheet, and forming an insulative container using a side wall blank and a floor blank. Reference is hereby made to U.S. application Ser. No. 14/106,276 filed on 13 Dec. 2013 and entitled PROCESS FOR FORMING CONTAINER BLANK for disclosure relating to a process of forming blanks used in forming a container, which application is incorporated in its entirety herein.

Insulative cellular non-aromatic polymeric material is used to form insulative cup 10. Insulative cup 10 includes a body 11 having sleeve-shaped side wall 18 and floor 20 as shown in FIGS. 2-4. Floor 20 is coupled to body 11 and cooperates with sleeve-shaped side wall 18 to form interior region 14 therebetween for storing food, liquid, or any suitable product. Body 11 also includes a rolled brim 16 coupled to an upper end of sleeve-shaped side wall 18 and a floor mount 17 coupled to a lower end of sleeve-shaped side wall 18 and to floor 20 as shown in FIG. 5. Reference is hereby made to U.S. App. Pub. No. 2012/0318805 filed on 7 Jun. 2012 and entitled INSULATED CONTAINER for disclosure relating to an insulated container, which application is incorporated in its entirety herein.

Floor mount 17 of body 11 is coupled to a lower portion of sleeve-shaped side wall 18 and to floor 20 and configured to support floor 20 in a stationary position relative to sleeve-shaped side wall 18 to form interior region 14 as suggested in FIGS. 2-4. Floor mount 17 includes a floor-retaining flange 26 coupled to floor 20, a web-support ring 126 coupled to the lower end of sleeve-shaped side wall 18 and arranged to surround floor-retaining flange 26, and a connecting web 25 arranged to interconnect floor-retaining flange 26 and web-support ring 126 as suggested in FIG. 4. Each of connecting web 25 and web-support ring 126 has an annular shape. Floor-retaining flange 26 has an annular shape. Each of floor-retaining flange 26, connecting web 25, and web-support ring 126 includes an inner layer having an interior surface mating with floor 20 and an overlapping outer layer mating with an exterior surface of inner layer as suggested in FIGS. 2 and 4.

Floor 20 of insulative cup 10 includes a horizontal platform 21 bounding a portion of interior region 14 and a platform-support member 23 coupled to horizontal platform 21 as shown, for example, in FIGS. 2 and 4. Platform-support member 23 is ring-shaped and arranged to extend downwardly away from horizontal platform 21 and interior region 14 into a space 27 provided between floor-retaining flange 26 and the web-support ring 126 surrounding floor-retaining flange 26 to mate with each of floor-retaining flange 26 and web-support ring 126 as suggested in FIGS. 3 and 4.

Platform-support member 23 of floor 20 has an annular shape and is arranged to surround floor-retaining flange 26 and lie in an annular space provided between horizontal platform 21 and connecting web 25 as suggested in FIG. 4. Each of floor-retaining flange 26, connecting web 25, and web-support ring 126 includes an inner layer having an interior surface mating with floor 20 and an overlapping outer layer mating with an exterior surface of inner layer Inner layer of each of floor-retaining flange 26, connecting web 25, and web-support ring 126 is arranged to mate with platform-support member 23.

Floor-retaining flange 26 of floor mount 17 is arranged to lie in a stationary position relative to sleeve-shaped side wall 18 and coupled to floor 20 to retain floor 20 in a stationary position relative to sleeve-shaped side wall 18 as suggested in FIGS. 2-4. Horizontal platform 21 of floor 20 has a perimeter edge mating with an inner surface of sleeve-shaped side wall 18 and an upwardly facing top side 20A bounding a portion of interior region 14 as suggested in FIG. 4.

In one illustrative embodiment, a method of producing an insulative cup comprises several steps. The method begins with an extruding step in which an insulative cellular non-aromatic polymeric material is extruded through a die 128 to produce tubular extrudate 124 as shown in FIG. 1. Tubular extrudate 124 has an interior surface (A) and an exterior surface (B). Interior surface (A) is arranged to bound central extrudate passageway 125 which extends along longitudinal axis 12 of tubular extrudate 124. Exterior surface (B) is arranged to face away from the central extrudate passageway 125 as shown in FIG. 1.

The method further includes a step of providing sleeve-shaped side wall 18 and a step of using a part of tubular extrudate 124 to form floor 20. Floor 20 is sized to mate with sleeve-shaped side wall 18 to establish insulative cup 10. Floor 20 is configured to have a first side 20A provided by interior surface (A) of a portion of tubular extrudate 124 and an opposite second side 20B provided by exterior surface (B) of a portion of tubular extrudate 124.

The method further includes a step of mating floor 20 to sleeve-shaped side wall 18. As a result, first side 20A of floor 20 forms a first boundary of interior region 14 formed in the insulative cup.

The using step described herein comprises several steps in illustrative embodiments. The using step begins with a slitting step in which tubular extrudate 124 is slit or cut to provide a strip 82 having first strip surface 82A defined by interior surface (A) of tubular extrudate 124 and opposite second strip surface 82B defined by exterior surface (B) of tubular extrudate 124. The using step further includes the step of cutting strip 82 to produce a floor blank having first side 20A and second side 20B. The using step further includes a step of folding floor blank to produce floor 20.

Floor 20 includes horizontal platform 21 and platform-support member 23 as shown in FIG. 2. Horizontal platform 21 includes first platform surface 21A and opposite second platform surface 21B. First platform surface 21A is arranged to face upwardly and provide the first boundary of interior region 14. Opposite second platform surface 21B is arranged to face downwardly. Platform-support member 23 is coupled to horizontal platform 21 and arranged to extend downwardly away from interior region 14.

The mating step described herein includes several steps in illustrative embodiments. The mating step begins with a step of orienting floor 20 to cause first side 20A to face toward sleeve-shaped side wall 18. Floor 20 and sleeve-shaped side wall 18 cooperate to define interior region 14 of insulative cup 10. The mating step also includes a step for mounting floor 20 to sleeve-shaped side wall 18 to lie in in a stationary position relative to sleeve-shaped side wall 18.

The providing step described herein includes several steps in illustrative embodiments. The providing step includes a step of using a different part of tubular extrudate 124 to form sleeve-shaped side wall 18. Sleeve-shaped side wall 18 is configured to have a first side 18A provided by interior surface (A) of a different portion of tubular extrudate 124 and an opposite second side 18B provided by exterior surface (B) of the different portion of tubular extrudate 124.

The mating step described herein includes multiple steps in illustrative embodiments. The mating step includes a step of orienting floor 20 to cause first side 20A to face toward sleeve-shaped side wall 18. First side 20A of floor 20 cooperates with sleeve-shaped side wall 18 to define a portion of interior region 14 of insulative cup. The mating step further includes a step of orienting sleeve-shaped side wall 18 to cause first side 18A to face toward floor 20. First side 18A of sleeve-shaped side wall 18 cooperates first side 20A of floor 20 to define another portion of interior region 14. The mating step also includes a step of mounting floor 20 to sleeve-shaped side wall 18 to lie in a stationary position relative to sleeve-shaped side wall 18 after the two orienting steps have been completed.

In an illustrative embodiment, a method of producing an insulative cup comprises multiple steps. The method includes a step of extruding tubular extrudate 124. Tubular extrudate 124 is made from an insulative cellular polymeric material in illustrative embodiments of the present disclosure. Tubular extrudate 124 has interior surface (A) and exterior surface (B). Interior surface (A) bounds central extrudate passageway 125 which extends along longitudinal axis 12 of tubular extrudate 124. Opposite exterior surface (B) is arranged to face away from central extrudate passageway 125.

The method further includes a step of forming sleeve-shaped side wall 18 from a first portion of tubular extrudate 124. The method further includes a second step of forming floor 20 from a second portion of tubular extrudate 124. Floor 24 has first side 20A provided by interior surface (A) of tubular extrudate 124 and opposite second side 20B provided by opposite exterior surface (B) of tubular extrudate 124.

The method also includes a step of orienting floor 20 to cause first side 20A to face toward sleeve-shaped side wall 18. The method includes the step of mounting floor 20 to sleeve-shaped side wall 18. As a result, insulative cup 10 is established and interior region 14 is formed between sleeve-shaped side wall 18 and floor 20. First side 20A of floor 20 provides a first boundary of interior region 14 of insulative cup 10. Sleeve-shaped side wall 18 includes first side 18A provided by interior surface (A) tubular extrudate 124 and opposite second side 18B provided by exterior surface (B) of tubular extrudate 124. The method further comprises a step of orienting sleeve-shaped side wall 18 to cause first side 18A to face toward floor 20 and provide the second boundary of interior region 14.

The forming step includes a step of slitting tubular extrudate 124 to provide a strip 82 made of insulative cellular non-aromatic polymeric material. Strip 82 has first strip surface 82A provided by inner surface (A) of tubular extrudate 124 and opposite second strip surface 82B provided by outer surface (B) of tubular extrudate 124. The forming step also includes a step of cutting strip 82 to produce a floor blank having first side 20A provided by first strip surface 82A and second side 20B provided by opposite second strip surface 82B. The forming step also includes a step of folding the floor blank to produce floor 20.

1. A method of producing an insulative cup, the method comprising the steps of
extruding an insulative cellular non-aromatic polymeric material through a die to produce a tubular extrudate having an interior surface bounding a central extrudate passageway extending along a longitudinal axis of the tubular extrudate and an exterior surface facing away from the central extrudate passageway,
providing a sleeve-shaped side wall,
using a part of the tubular extrudate to form a floor sized to mate with the sleeve-shaped side wall to establish the insulative cup and configured to have a first side provided by the interior surface of a portion of the tubular extrudate and an opposite second side provided by the exterior surface of a portion of the tubular extrudate, and
mating the floor to the sleeve-shaped side wall to cause the first side of the floor to form a first boundary of an interior region formed in the insulative cup.

2. The method of claim 1, wherein the using step further comprises the steps of
slitting the tubular extrudate to provide a strip of insulative cellular non-aromatic polymeric material having a first strip surface defined by the interior surface of the tubular extrudate and an opposite second strip surface defined by the exterior surface of the tubular extrudate,
cutting the strip of insulative cellular non-aromatic polymeric material to produce a floor blank providing the first side and the second side, and
folding the floor blank to produce the floor including a horizontal platform having a first platform surface arranged to face upwardly and providing the first boundary of the interior region and an opposite second platform surface arranged to face downwardly and a platform-support member coupled to the horizontal platform and arranged to extend downwardly away from the interior region.

3. The method of claim 2, wherein the mating step includes the steps orienting the floor to cause the first side to face toward the sleeve-shaped side wall and cooperate therewith to define the interior region of the insulative cup and then mounting the floor in a stationary position relative to the sleeve-shaped side wall.

4. The method of claim 1, wherein the providing step includes the steps of using a different part of the tubular extrudate to form the sleeve-shaped side wall configured to have a first side provided by the interior surface of a different portion of the tubular extrudate and an opposite second side provided by the exterior surface of the different portion of the tubular extrudate.

5. The method of claim 4, wherein the mating step includes the steps orienting the floor to cause the first side of the floor to face toward the sleeve-shaped side wall and cooperate therewith to define a portion of the interior region of the insulative cup, orienting the sleeve-shaped side wall to cause the first side of the sleeve-shaped side wall to face toward the floor and cooperate therewith to define another portion of the interior region, and then mounting the floor in a stationary position relative to the sleeve-shaped side wall.

6. A method of producing an insulative cup, the method comprising the steps of
extruding a tubular extrudate made from an insulative cellular polymeric material, the tubular extrudate having an interior surface bounding a central extrudate passageway extending along a longitudinal axis of the tubular extrudate and an opposite exterior surface facing away from the central extrudate passageway,
forming a sleeve-shaped side wall from a first portion of the tubular extrudate,
forming a floor made from a second portion of the tubular extrudate and having a first side provided by the interior surface of the tubular extrudate and an opposite second side provided by the opposite exterior surface of the tubular extrudate,
orienting the floor to cause the first side to face toward the sleeve-shaped side wall,
mounting the floor to the sleeve-shaped side wall to establish the insulative cup and form an interior region therein between the sleeve-shaped side wall and the floor so that the first side of the floor provides a first boundary of the interior region of the insulative cup.

7. The method of claim 6, wherein the sleeve-shaped side wall further includes a first side provided by the interior surface the tubular extrudate and an opposite second side provided by the exterior surface of the tubular extrudate.

8. The method of claim 7, further comprising the step of orienting the sleeve-shaped side wall to cause the first side of the sleeve-shaped side wall to face toward the floor and provide a second boundary of the interior region.

9. The method of claim 8, wherein the forming the floor step includes the steps of
slitting the tubular extrudate to provide a strip of insulative cellular non-aromatic polymeric material having a first strip surface provided by the inner surface of the tubular extrudate and an opposite second strip surface provided by the outer surface of the tubular extrudate,
cutting the strip of insulative cellular non-aromatic polymeric material to produce a floor blank having the first side of the floor provided by the first strip surface and the second side of the floor provided by the opposite second strip surface, and
folding the floor blank to produce the floor.

10. The method of claim 9, wherein the floor includes a horizontal platform having a first platform surface arranged to face upwardly to provide the first boundary of the interior region and an opposite second platform surface arranged to face downwardly and a platform-support member coupled to the horizontal platform and arranged to extend downwardly away from the interior region.
